(19) United States
(12) Patent Application Publication
(10) Pub. No.: US 2009/0307920 A1
(43) Pub. Date: Dec. 17, 2009

(54) TAPE MEASURE

(76) Inventor: Sidney Louis Schrage, Red Bluff, CA (US)

Correspondence Address: ADVANTIA LAW GROUP, 9035 SOUTH 1300 EAST, SUITE 200, SANDY, UT, 84094, US

(21) Appl. No.: 12/396,835

(22) Filed: Mar. 3, 2009

Related U.S. Application Data
(60) Provisional application No. 61/061,479, filed on Jun. 13, 2008.

(51) Int. Cl. G01B 3/10

(52) U.S. Cl. 33/760

(57) ABSTRACT

There is a tape measure configured for one-hand operation. The tape measure includes a protective casing and a coiled measuring tape. The tape measure includes an audio recorder and a speaker module coupled to the protective casing, wherein the speaker module is configured to audibly broadcast recorded audio information. The tape measure also includes a locking mechanism and a light module; wherein the light module is configured to activate when the locking mechanism is actuated, thereby disposing light over a portion of the measuring tape. The tape measure includes a control module in communication with each of the audio recorder, speaker module, light module, and magnetic locking mechanism, configured to provide controls thereto for each. The control module is disposed substantially above the magnetic locking mechanism on the protective housing and operable with a single digit of a hand, while the hand is grasping the protective casing.

### CROSS-REFERENCE TO RELATED APPLICATIONS

This invention claims priority, under 35 U.S.C. §120, to the U.S. Provisional Patent Application No. 61/061,479 to Sidney Louis Schrage filed on Jun. 13, 2008, which is incorporated by reference herein.

### BACKGROUND OF THE INVENTION

1. Field of the Invention

The present invention relates to tape measures, specifically to a one-hand-operable recording tape measure.

2. Description of the Related Art

A tape measure, or measuring tape, is a flexible form of ruler. It consists of a ribbon of cloth, plastic, or metal with linear-measure markings, often in both imperial and metric units. It is a convenient, common measuring tool. Its flexibility allows for a measure of great length to be easily carried in pocket or tool kit and permits one to measure around curves or corners. However, current tape measures typically have to be operated with two hands. The user typically has to secure the locking mechanism of the tape measure and then read the distance and then record the distance. Recording the distance includes reading the measuring tape and writing, with a pencil and pad, the measurement down. This is particular difficult to perform when the user is on a ladder fifteen feet high, in a tight area, or suspended in the air. A type of vertigo may develop and the user may lose their equilibrium which may result in serious, if not fatal, injuries. The user is risking his/her safety while trying to perform a simple measurement of a distance. In addition, individuals with hand or arm defects or amputees have a difficult time in operating tape measures and then recording measurements. Some improvements have been made in the field. Examples of references related to the present invention are described below, and the supported teachings of each reference are incorporated by reference herein:

U.S. Pat. No. 5,802,732, issued to Malone, discloses a combination measuring instrument such as an elongated and retractable tape measuring device is associated with an audio recording apparatus which enables a user to record measurements observed on the tape measure device simultaneously with the act of performing the measurement and which permits the subsequent playback of the recorded information for use in a later discrete step of manufacturing or utilizing the recorded information. The recording device may be positioned in or on the housing of the measuring device so that the user may conveniently record the observed measurement orally for later reuse.

U.S. Pat. No. 3,862,761, issued to Conley, discloses a drawstring on a spring wound phonograph is wound about a string drum connected to a tape-measure drum which carries a tape measure for winding drawstring on string drum when tape measure is withdrawn to make a measurement. Phonograph spring recoils the tape measure during playing of a message. The tape measure may be retained in an extended position by a releasable latch.

U.S. Pat. No. 5,396,578, issued to Howes, discloses an audio recording and playback system with a measuring device, a unique integrated system is realized which enables users to easily record measured distances and have the measured distances subsequently played back for use. In the preferred embodiment, the audio recording and play back system is constructed in cooperative association with a tape measuring device and is automatically powered whenever the tape is extended from the housing. Then, by pressing an activation switch and orally stating the measurements that have been taken, the orally enunciated information is automatically stored in an associated analog storage array for being subsequently played back whenever required by the user. In this way, an easily employed and particularly convenient system is realized which eliminates the need for manually recording measurements.

U.S. Pat. No. 5,983,514, issued to Lindesy, discloses a tape measure including an electronic keypad and display for recording and viewing measurements is disclosed. The keypad includes up and down buttons, save and recall buttons, a set button and a clear/on button. The up and down buttons are used to selectively increment and decrement numeric values representing units of measurements, which are displayed on the display. Measurements are entered and displayed in feet, inches, and sixteenths of an inch in the English system, or in metric units. After manually measuring a distance using a coiled measuring tape, a user presses the up and down buttons to specify the distance measured, then presses the save button to store the measurements. The recall button is used to recall previously stored measurements.

U.S. Pat. No. 4,462,160, issued to Cohen et al., discloses an illuminated retractable tape measure having a casing which contains a coiled tape rule whose free end extends through an opening in the casing. A lock arrangement locks the tape against automatic retraction into the casing. In the lock arrangement, a locking member is mounted in the casing with an end thereof engageable with the tape to hold the same against a portion of the casing in a locking position. The end of the locking member is moved out of engagement with the tape when an unlocked position is established. A slide actuator pivots the lock member between its locked and unlocked positions. A small lamp or lamps is incorporated in the casing for illuminating the ruling on the tape measure, and the actuator closes a switch when the actuator is moved to its locked position to light the lamp. This feature facilitates reading measurements on the tape measure, especially in adverse lighting conditions.

U.S. Pat. No. 4,580,347, issued to McKnight, discloses a housing for a flexible recoilable measuring tape which includes a battery operated light for emitting light directly onto the tape; a pair of magnetic foot members attached to the base of the apparatus for adhering onto metal beams or the like; and a flexible holder wherein the belt or waistband is engaged between a flexible arm and the apparatus for placement of the apparatus when not in use. There is also included a recoilable line marker attached to the side of the apparatus.

The inventions heretofore known suffer from a number of disadvantages which include being limited in application, being limited in use, being difficult to use, being inconvenient, being bulky, being unduly complex, and being ineffective.

What is needed is a tape measure that solves one or more of the problems described herein and/or one or more problems that may come to the attention of one skilled in the art upon becoming familiar with this specification. Specifically, the invention is intended to enable a user to support oneself at a high elevation with one hand and take and record a measurement using a tape measure with just using the other hand; thereby making recording measurements about high elevations significantly safer.

### SUMMARY OF THE INVENTION

The present invention has been developed in response to the present state of the art, and in particular, in response to the problems and needs in the art that have not yet been fully solved by currently available tape measures. Accordingly, the present invention has been developed to provide a convenient and efficient one-hand operable recording tape measure.

In one embodiment of the invention, there is a tape measure configured for one-hand operation. The tape measure may include a protective casing; wherein the protective casing is water-resistant. The tape measure may also include a coiled measuring tape disposed within the protective casing and configured to extend laterally outside the protective casing as uncoiled. In addition, the tape measure may include an audio recorder coupled to the protective casing and configured to record audio information. The tape measure may further include a speaker module coupled to the protective casing, wherein the speaker module is in communication with the audio recorder and configured to audibly broadcast recorded audio information. The speaker module may be disposed about a top surface of the protective casing and extends down along each side of the protective casing.

Furthermore, the tape measure may include a magnetic locking mechanism coupled to the protective casing; wherein the magnetic locking mechanism includes a magnet configured to secure the coiled tape at a selectable distance thereby preventing lateral displacement of the measuring tape. The tape measure may also include a light module coupled to the protective casing, in communication with the magnetic locking mechanism; wherein the light module is configured to activate when the locking mechanism is actuated, thereby disposing light over a portion of the measuring tape.

Moreover, the tape measure may include a control module disposed within the protective casing and in communication with each of the audio recorder, speaker module, light module, and magnetic locking mechanism; wherein the control module is configured to provide controls thereto for each. The control module may include a play module configured to audibly broadcast recorded audio information and a rewind module configured to replay audio information. The control module may also include a playback mode, wherein when activated, the playback mode audibly broadcasts recorded audible information. The control module may further include a clear module configured to erase audio information and a record module configured to record audio information; wherein the record module is disposed substantially above the magnetic locking mechanism on the protective housing. In addition, the play module, rewind module, clear module, and record module are disposed adjacent to each other and operable with a single digit of a hand, while the hand is grasping the protective casing;

The tape measure may additionally include a display module coupled to the protective casing; wherein the display module is configured to display a distance of the measuring tape. The tape measure may further include a magnetic coupling member disposed on an end of the uncoiled measuring tape, configured to selectably attach to metal.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a tape measure, according to one embodiment of the invention;

FIG. 2 is a front elevational view of a tape measure, according to one embodiment of the invention;

FIG. 3 is a top plan view of a tape measure, according to one embodiment of the invention;

FIG. 4 is a module diagram of a tape measure, according to one embodiment of the invention; and

FIG. 5 is a cross sectional view of a tape measure, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to: computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

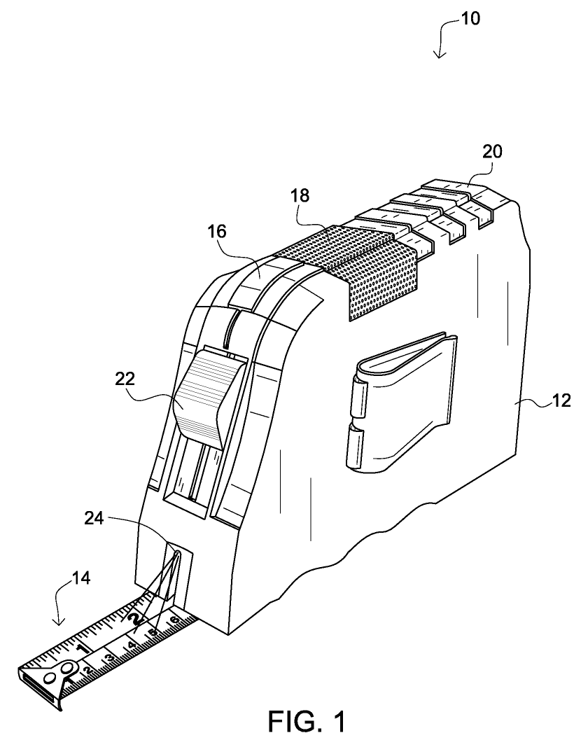

FIG. 1 is a perspective view of a tape measure 10, according to one embodiment of the invention, wherein the tape measure 10 is configured for one-hand operation. The tape measure 10 includes a protective casing 12; wherein the protective casing 12 may be water-resistant. The tape measure 10 also includes a coiled measuring tape disposed within the protective casing 12 and configured to extend laterally outside the protective casing as uncoiled 14. In addition, the tape measure 10 includes an audio recorder 16 coupled to the protective casing 12 and configured to record audio information. The tape measure 10 includes a speaker module 18 coupled to the protective casing 12, wherein the speaker module 18 is in communication with the audio recorder 16 and configured to audibly broadcast recorded audio information. The speaker module 18 is disposed about a top surface 20 of the protective casing 12 and extends down along each side of the protective casing 12. A non-limiting example of an audio recorder may be an audio playback and recorder module as disclosed in U.S. Pat. No. 6,167,233, issued to Gresser Jr. et al., which is hereby incorporated for its supported teachings.

Additionally, the tape measure 10 includes a magnetic locking mechanism 22 coupled to the protective casing 12; wherein the magnetic locking mechanism 22 is configured to secure the coiled tape at a selectable distance thereby preventing lateral displacement of the measuring tape. The tape measure 10 also includes a light module 24 coupled to the protective casing 12, in communication with the magnetic locking mechanism 22; wherein the light module 24 is configured to activate when the locking mechanism 22 is actuated, thereby disposing light over a portion of the measuring tape. Furthermore, the tape measure 10 includes a power module 30 configured to provide power to the tape measure and its components and modules. One skilled in the art would appreciate that the magnetic locking mechanism may be but not limited to a standard friction locking mechanism and still perform its intended function.

In operation of one embodiment of the invention, a user with one-hand gripping the protective casing turns on the tape measure by activating the power module. The user then extends the measuring tape to a selectable distance and secures the magnetic locking mechanism; thereby activating the light module to dispose light over a portion of the measuring tape. The user then activates the audio recorder and recites the distance selected, thereby storing the recited distance. The user may then replay the audio information. As illustrated in FIG. 1, the tape measure is configured for either right hand or left hand users to operate.

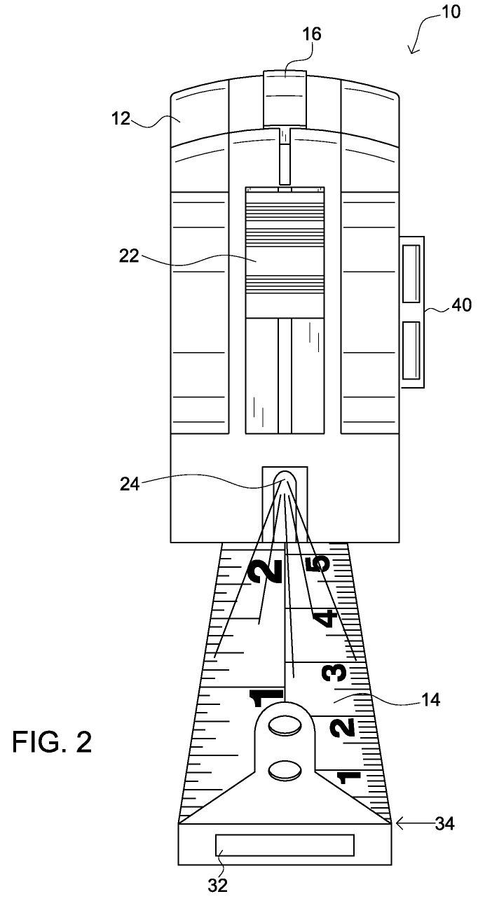

FIG. 2 is a front elevational view of a tape measure 10, according to one embodiment of the invention, wherein the tape measure 10 includes a protective casing 12. The tape measure 10 also includes a coiled measuring tape disposed within the protective casing 12 and configured to extend laterally outside the protective casing as uncoiled 14. In addition, the tape measure 10 includes a magnetic locking mechanism 22 coupled to the protective casing 12; wherein the magnetic locking mechanism 22 is configured to secure the coiled tape at a selectable distance thereby preventing lateral displacement of the measuring tape. The tape measure 10 also includes a light module 24 coupled to the protective casing 12, in communication with the magnetic locking mechanism 22; wherein the light module 24 is configured to activate when the locking mechanism 22 is actuated, thereby disposing light over a portion of the measuring tape. Furthermore, the tape measure 10 includes a power module 30 configured to provide power to the tape measure and its components and modules. The tape measure 10 further includes a magnetic coupling member 32 disposed on an end 34 of the uncoiled measuring tape 14, configured to selectably attach to metal. The tape measure 10 also includes a clip 40 configured to secure to a user.

In operation of one embodiment of the invention, a user, with one-hand gripping the protective casing, turns on the tape measure by activating the power module. The user extends the measuring tape and secures the magnetic coupling member to a metal member. The user then extends the measuring tape to a selectable distance and secures the magnetic locking mechanism; thereby activating the light module to dispose light over a portion of the measuring tape. The user then activates the audio recorder and recites the distance selected, thereby storing the recited distance. The user may then replay the audio information. In addition, the tape measure may be configured to automatically begin recording audio information once the magnetic locking mechanism is secured to a selectable distance. Furthermore, the user may selectably attach the clip to an article of clothing, tool belt, etc. to secure the tape measure to the user.

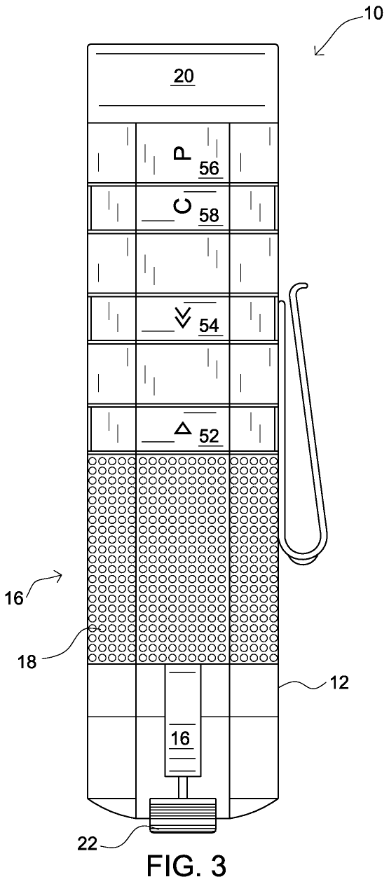

FIG. 3 is a top plan view of a tape measure 10, according to one embodiment of the invention, wherein the tape measure 10 includes a protective casing 12. The tape measure 10 includes an audio recorder 16 coupled to the protective casing 12 and configured to record audio information. The tape measure 10 includes a speaker module 18 coupled to the protective casing, wherein the speaker module 18 is in communication with the audio recorder 16 and configured to audibly broadcast recorded audio information. The speaker module 18 is disposed about a top surface 20 of the protective casing and extends down along each side of the protective casing.

In addition, the tape measure 10 includes a magnetic locking mechanism 22 coupled to the protective casing 12. The tape measure 10 includes a control module disposed within the protective casing 12 and in communication with each of the audio recorder 16, speaker module 18, light module, and magnetic locking mechanism 22; wherein the control module is configured to provide controls thereto for each. The control module includes a play module 52 configured to audibly broadcast recorded audio information and a rewind module 54 configured to replay audio information. The control module may also include a playback mode 56, wherein when activated, the playback mode 56 audibly broadcasts the last recorded audible information. The control module further includes a clear module 58 configured to erase audio information.

Furthermore, the audio recorder 16 includes a record module configured to record audio information; wherein the record module is disposed substantially above the magnetic locking mechanism 22 on the protective housing 12. In addition, the play module 52, rewind module 54, clear module 58, and record module 16 are disposed adjacent to each other and operable with a single digit of a hand, while the hand is grasping the protective casing.

In operation of one embodiment of the invention, a user, with one-hand gripping the protective casing, turns on the tape measure by activating the power module. The user extends the measuring tape to a selectable distance and secures the magnetic locking mechanism; thereby activating the light module to dispose light over a portion of the measuring tape. The user then activates the audio recorder and recites the distance selected, thereby storing the recited distance. The user may then replay the audio information by activating the rewind module or the playback module and then activating the play module. The user may clear audio information by activating the clear module.

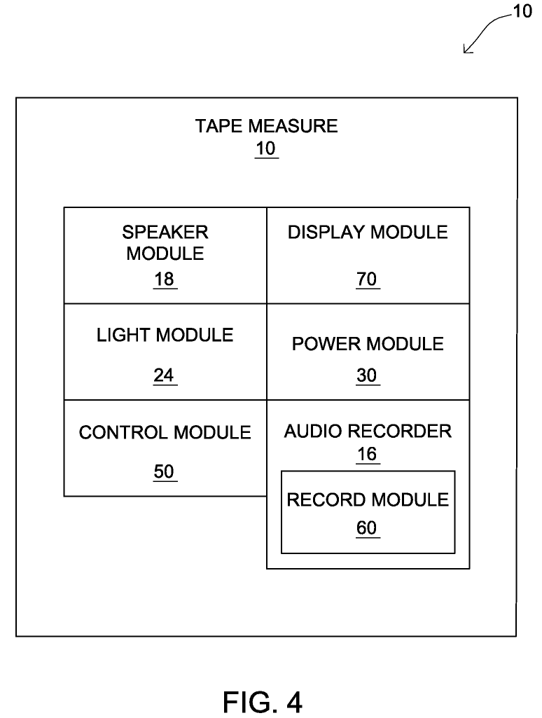

FIG. 4 is a module diagram of a tape measure 10, according to one embodiment of the invention, wherein the tape measure 10 includes an audio recorder 16. The audio recorder 16 includes a record module 60 configured to record audio information. The tape measure 10 also includes a speaker module 18 in communication with the audio recorder 16 and configured to audibly broadcast recorded audio information. The tape measure 10 further includes a light module 24 configured to activate when the locking mechanism is actuated, thereby disposing light over a portion of the measuring tape.

In addition, the tape measure 10 includes a control module 50 in communication with each of the audio recorder 16, speaker module 18, and light module 24; wherein the control module 50 is configured to provide controls thereto for each. The control module 50 includes a play module configured to audibly broadcast recorded audio information and a rewind module configured to replay audio information. The control module 50 also include a playback mode, wherein when activated, the playback mode audibly broadcasts recorded audible information. The control module 50 further includes a clear module configured to erase audio information. The audio recorder 16 includes a record module 60 configured to record audio information. The tape measure 10 may additionally include a display module 70 configured to display a distance of the measuring tape.

In operation of one embodiment of the invention, a user, with one-hand gripping the protective casing, turns on the tape measure by activating the power module. The user extends the measuring tape to a selectable distance and secures the magnetic locking mechanism; thereby activating the light module to dispose light over a portion of the measuring tape. The user then activates the audio recorder and recites the distance selected, thereby storing the recited distance. The user may then replay the audio information. In addition, the tape measure may be configured to automatically begin recording audio information once the magnetic locking mechanism is secured to a selectable distance.

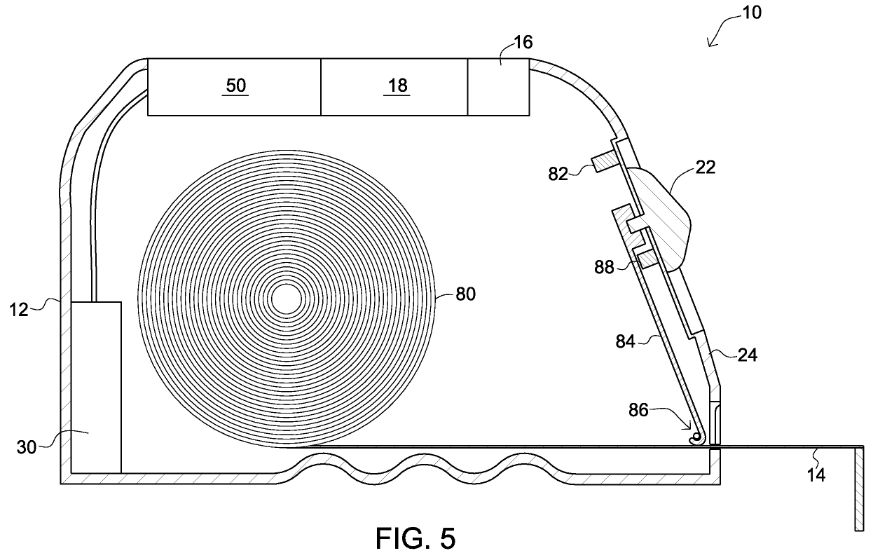

FIG. 5 is a cross sectional view of a tape measure, according to one embodiment of the invention, wherein the tape measure 10 includes a protective casing 12. The tape measure 10 also includes a coiled measuring tape 80 disposed within the protective casing 12 and configured to extend laterally outside the protective casing as uncoiled 14. In addition, the tape measure 10 includes an audio recorder 16 coupled to the protective casing 12 and configured to record audio information. The tape measure 10 includes a speaker module 18 coupled to the protective casing 12, wherein the speaker module 18 is in communication with the audio recorder 16 and configured to audibly broadcast recorded audio information.

Additionally, the tape measure 10 includes a magnetic locking mechanism 22 coupled to the protective casing 12; wherein the magnetic locking mechanism 22 includes a magnet 82 configured to secure the coiled tape 80 at a selectable distance thereby preventing lateral displacement of the measuring tape. The magnetic locking mechanism 22 also includes an elongated member 84 configured to extend around a pivot point 86, thereby securing the measuring tape and preventing lateral displacement. The magnetic locking mechanism further includes a second magnet 88 configured to secure the magnetic locking mechanism in a stored position when the measuring tape is not in use. The tape measure 10 also includes a light module 24 coupled to the protective casing 12, in communication with the magnetic locking mechanism 22; wherein the light module 24 is configured to activate when the locking mechanism 22 is actuated, thereby disposing light over a portion of the measuring tape. Furthermore, the tape measure 10 includes a power module 30 configured to provide power to the tape measure and its components and modules and a control module 50 in communication with each of the audio recorder 16, speaker module 18, and light module 24; wherein the control module 50 is configured to provide controls thereto for each.

In operation of one embodiment of the invention, a user with one-hand gripping the protective casing turns on the tape measure by activating the power module. The user then extends the measuring tape to a selectable distance and secures the magnetic locking mechanism by lifting upwards on the magnetic locking mechanism thereby engaging the magnet disposed within the protective casing. This configuration is advantageous, because in normal operation of a typical tape measure the user presses downwards to lock the measuring tape in place. However, with the tape measure, including an audio recorder, it would be difficult to press downward on the magnetic locking mechanism and then activate the audio recorder. As configured, the user with one fluid motion lifts up the magnetic locking mechanism and activates the audio recorder; thereby activating the light module to dispose light over a portion of the measuring tape and to record audio information.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Additionally, although the figures illustrate a control module including a play module, rewind module, playback module, and clear module illustrated as buttons; one skilled in the art would appreciate that the buttons may be disposed within the display module such as a touch-screen display module. Furthermore, it is shown in one embodiment that the buttons are configured about a top surface of the protective casing. It is envisioned that in another embodiment of the invention, the buttons may be configured about a top surface and a bottom surface of the protective casing; wherein the buttons are still configured for one-hand operation. It is also envisioned in yet another embodiment of the invention that the buttons may be disposed about a top surface and a side surface of the protective casing; wherein the buttons are still configured for one-hand operation.

It is envisioned; one skilled in the art would appreciate, that the control module may include a communication module; wherein the communication module is configured to send the audio information to a remote device configured to store the audio information. A non-limiting example of a remote device may be a computer or PDA.

It is also envisioned that one skilled in the art would appreciate that the measurement units may be, but not limited to the metric system, the U.S. system, or any other international system and still perform its intended function. In particular, the control module may include a toggle module to change the measurement units of the tape measure.

In addition, it is envisioned that the tape measure is configured for right-hand or left-hand use. The speaker module is configured to extend down both sides of the casing to enable a left-hand or a right-hand user to operate the tape measure without covering the speaker module. Furthermore, the control module including a play module, rewind module, playback module, and clear module are configured to be disposed about the casing to be operable by one digit of either the left-hand or right-hand; thereby increasing the versatility of the tape measure.

It is expected that there could be numerous variations of the design of this invention. Additionally, although the figures illustrate specific embodiments, it is envisioned, one skilled in the art would appreciate, that further embodiments may include combinations not heretofore illustrated of the illustrated features and structures and still perform its intended function.

It is envisioned that the magnetic locking mechanism may be a standard friction locking mechanism, wherein friction locking mechanism is configured to secure the coiled tape at a selectable distance thereby preventing lateral displacement of the measuring tape. The tape measure includes a light module coupled to the protective casing, in communication with the friction locking mechanism; wherein the light module is configured to activate when the friction locking mechanism is actuated, thereby disposing light over a portion of the measuring tape.

Finally, it is envisioned, one skilled in the art would appreciate, that the components of the device may be constructed of a variety of materials, including, but not limited to: plastic, rubber, textile, metal, ceramic, fiber, wood, and combinations thereof, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of, or to consist essentially of, one or more of the features, functions, structures, methods described herein.

What is claimed is:

1. A tape measure configured for one-hand operation, comprising:
a) a protective casing;
b) a coiled measuring tape disposed within the protective casing and configured to extend laterally outside the protective casing as uncoiled;
c) an audio recorder coupled to the protective casing configured to record audio information;
d) a speaker module coupled to the protective casing, in communication with the audio recorder and configured to audibly broadcast recorded audio information;
e) a magnetic locking mechanism coupled to the protective casing and configured to secure the coiled tape at a selectable distance thereby preventing lateral displacement of the measuring tape;
f) a light module coupled to the protective casing, in communication with the magnetic locking mechanism and configured to activate when the locking mechanism is actuated, thereby disposing light over a portion of the measuring tape; and
g) a control module disposed within the protective casing and in communication with each of the audio recorder, speaker module, light module, and magnetic locking mechanism, wherein the control module is configured to provide controls thereto for each and wherein the control module is configured to be operated by a single hand of the user such that the controls are all disposed adjacent to each other and operable with a single digit of a hand, while the hand is grasping the protective casing.

2. The tape measure of claim 1, wherein the control module further includes:
a) a play module configured to audibly broadcast recorded audio information;
b) a rewind module configured to replay audio information;
c) a clear module configured to erase audio information; and
d) a record module configured to record audio information; wherein the play module, rewind module, clear module, and record module are disposed adjacent to each other and operable with a single digit of a hand, while the hand is grasping the protective casing.

3. The tape measure of claim 2, wherein the record module is disposed substantially above the magnetic locking mechanism on the protective housing.

4. The tape measure of claim 1, wherein the tape measure further includes a display module coupled to the protective casing; wherein the display module is configured to display a distance of the measuring tape.

5. The tape measure of claim 1, wherein the speaker module is disposed about a top surface of the protective casing and extends down along each side of the protective casing.

6. The tape measure of claim 1, wherein the control module further includes a playback mode, wherein when activated, the playback mode audibly broadcasts recorded audible information.

7. The tape measure of claim 1, wherein the tape measure further comprises a magnetic coupling member disposed on an end of the uncoiled measuring tape, configured to selectably attach to metal.

8. The tape measure of claim 1, wherein the magnetic locking mechanism includes a magnet configured to secure the coiled measuring tape preventing lateral displacement.

9. The tape measure of claim 1, wherein the protective casing is water-resistant.

10. A tape measure configured for one-hand operation, consisting of:
a) a protective casing;
b) a coiled measuring tape disposed within the protective casing and configured to extend laterally outside the protective casing as uncoiled;
c) an audio recorder coupled to the protective casing configured to record audio information;
d) a speaker module coupled to the protective casing, in communication with the audio recorder and configured to audibly broadcast recorded audio information;
e) a magnetic locking mechanism coupled to the protective casing and configured to secure the coiled tape at a selectable distance thereby preventing lateral displacement of the measuring tape;
f) a light module coupled to the protective casing, in communication with the magnetic locking mechanism and configured to activate when the locking mechanism is actuated, thereby disposing light over a portion of the measuring tape; and
g) a control module disposed within the protective casing and in communication with each of the audio recorder, speaker module, light module, and magnetic locking mechanism, wherein the control module is configured to provide controls thereto for each and wherein the control module is configured to be operated by a single hand of the user such that the controls are all disposed adjacent to each other and operable with a single digit of a hand, while the hand is grasping the protective casing.

11. The tape measure of claim 10, wherein the control module further includes:
a) a play module configured to audibly broadcast recorded audio information;
b) a rewind module configured to replay audio information;
c) a clear module configured to erase audio information; and
d) a record module configured to record audio information; wherein the play module, rewind module, clear module, and record module are disposed adjacent to each other and operable with a single digit of a hand, while the hand is grasping the protective casing.

12. The tape measure of claim 11, wherein the record module is disposed substantially above the magnetic locking mechanism on the protective housing.

13. The tape measure of claim 12, wherein the tape measure further includes a display module coupled to the protective casing; wherein the display module is configured to display a distance of the measuring tape.

14. The tape measure of claim 13, wherein the speaker module is disposed about a top surface of the protective casing and extends down along each side of the protective casing.

15. The tape measure of claim 14, wherein the control module further includes a playback mode, wherein when activated, the playback mode audibly broadcasts recorded audible information.

16. The tape measure of claim 15, wherein the tape measure further comprises a magnetic coupling member disposed on an end of the uncoiled measuring tape, configured to selectably attach to metal.

17. The tape measure of claim 16, wherein the magnetic locking mechanism includes a magnet configured to secure the coiled measuring tape preventing lateral displacement.

18. The tape measure of claim 17, wherein the protective casing is water-resistant.

19. A tape measure configured for one-hand operation, consisting of:
a) a protective casing; wherein the protective casing is water-resistant;
b) a coiled measuring tape disposed within the protective casing and configured to extend laterally outside the protective casing as uncoiled;
c) an audio recorder coupled to the protective casing configured to record audio information;
d) a speaker module coupled to the protective casing, in communication with the audio recorder and configured to audibly broadcast recorded audio information; wherein the speaker module is disposed about a top surface of the protective casing and extends down along each side of the protective casing;
e) a magnetic locking mechanism coupled to the protective casing; wherein the magnetic locking mechanism includes a magnet configured to secure the coiled tape at a selectable distance thereby preventing lateral displacement of the measuring tape;
f) a light module coupled to the protective casing, in communication with the magnetic locking mechanism and configured to activate when the locking mechanism is actuated, thereby disposing light over a portion of the measuring tape;
g) a control module disposed within the protective casing and in communication with each of the audio recorder, speaker module, light module, and magnetic locking mechanism, wherein the control module is configured to provide controls thereto for each; wherein the control module further includes:
g1) a play module configured to audibly broadcast recorded audio information;
g2) a rewind module configured to replay audio information;
g3) a playback mode, wherein when activated, the playback mode audibly broadcasts recorded audible information;
g4) a clear module configured to erase audio information; and
g5) a record module configured to record audio information; wherein the record module is disposed substantially above the magnetic locking mechanism on the protective housing; wherein the play module, rewind module, clear module, and record module are disposed adjacent to each other and operable with a single digit of a hand, while the hand is grasping the protective casing;
h) a display module coupled to the protective casing; wherein the display module is configured to display a distance of the measuring tape; and
i) a magnetic coupling member disposed on an end of the uncoiled measuring tape, configured to selectably attach to metal.
